(19) United States
(12) Patent Application Publication
(10) Pub. No.: US 2025/0375982 A1
(43) Pub. Date: Dec. 11, 2025

(54) Spring Compression Casters and Jackstand Apparatus

(71) Applicant: Robert Bosch GmbH, Stuttgart (DE)

(72) Inventor: Daniel Newkirk, Owatanna, MN (US)

(21) Appl. No.: 18/734,390

(22) Filed: Jun. 5, 2024

(51) Int. Cl. B60B 33/04; B60B 33/00; B62B 3/10

(52) U.S. Cl. CPC B60B 33/045; B60B 33/0049; B60B 33/0068; B62B 3/10

(57) ABSTRACT

A caster having a spring feature configured to compress along the stem of the caster when subject to load. The spring achieves maximum compression when subjected to a maximum specified load value. One or more casters may be used in tandem with a jackstand apparatus. When the jackstand is presented without any additional force, the combined spring force of all casters utilized is sufficient to support the weight of the jackstand without achieving maximum compression. When subject to a sufficiently large additional force, each of the springs will achieve maximum compression, and the jackstand apparatus will interact with the supporting terrain directly, resulting a direct transfer of additional load to the terrain through the jackstand apparatus. Some embodiments may comprise a distinct jackstand and cart configuration. Some embodiments may comprise an integrated configuration.

### TECHNICAL FIELD

This disclosure relates to hand tools. More specifically, this disclosure is related to hand tools for use in automotive repair shops.

### BACKGROUND

Jackstands are used to prop up automobiles during service. Because automobiles can be quite heavy, jackstands need to be robust to support a large amount of weight. Existing jackstands can be heavy to move by hand and require a user to lift from a suboptimal ergonomic posture.

What is desired is a jackstand that can be placed easily, accurately, and ergonomically without affecting the stability or capacity of the jackstand.

### SUMMARY

One aspect of this disclosure is directed to a caster assembly comprising a stem defining a first axis, a shell comprising a proximal end and a distal end, an axle coupled to the shell at the distal end, a wheel disposed about the axle, a spring extending along at least a portion of the stem, and a collar at least partially disposed around the stem and spring. The shell is coupled to the stem at the proximal end and coupled such that the shell is rotatable about the first axis. The axle defines a second axis orthogonal to the first axis. The wheel is rotatable about the second axis. The collar is configured to receive a load and transfer the load onto the spring.

Another aspect of this disclosure is directed to a cart comprising a shelf having a top surface and a bottom surface, the top surface configured to receive a load and the bottom surface being disposed at a clearance distance over a terrain surface supporting the cart. The cart further comprises a caster coupled to the shelf. The caster has a configuration that includes a stem defining a first axis, a shell comprising a proximal end and a distal end, an axle coupled to the shell at the distal end, the axle defining a second axis orthogonal to the first axis, a wheel disposed about the axle, a spring extending along at least a portion of the stem, and a collar at least partially disposed around the stem and spring, the collar configured to receive a load and transfer the load onto the spring. The shell is coupled to the stem at the proximal end and coupled such that the shell is rotatable about the first axis. The wheel is rotatable about the second axis. The shelf is configured to transfer a received load to the collar such that the clearance distance is maximized when the shelf is not subject to a load, wherein the spring is maximally displaced when subjected to a load greater than a maximum load for the spring, and wherein the maximized clearance distance is not greater than the maximum displacement.

A further aspect of this disclosure is directed to a jackstand having a base member having a top surface and a bottom surface, the bottom surface disposed at a clearance distance over a terrain surface supporting the jackstand. The jackstand further comprises a support arm configured to extend from the top surface and receive a load. The jackstand further comprises a caster coupled to the support body. The caster has a configuration including a stem defining a first axis, a shell comprising a proximal end and a distal end, an axle coupled to the shell at the distal end and defining a second axis orthogonal to the first axis, a wheel disposed about the axle and rotatable about the second axis, a spring extending along at least a portion of the stem, and a collar at least partially disposed around the stem and spring. The shell is coupled to the stem at the proximal end and coupled such that the shell is rotatable about the first axis. The collar configured is to receive a load and transfer the load onto the spring. The base member is configured to transfer a received load of the support arm to the collar such that the clearance distance is maximized when the support arm is not subject to a load. The spring is maximally displaced when subjected to a load greater than a maximum load for the spring. The maximized clearance distance is not greater than the maximum displacement.

The above aspects of this disclosure and other aspects will be explained in greater detail below with reference to the attached drawings.

### BRIEF DESCRIPTION OF THE DRAWINGS

FIG. 1 is an exploded view of a caster having a spring.

FIG. 2 is a view of a caster having a spring.

FIG. 3 is an alternative view of a caster having a spring illustrating additional features.

FIG. 4 is an exploded view of a spring of a caster and related components, illustrating additional features of the depicted components.

FIG. 5 is an illustration of a cart utilizing a plurality of casters having a spring.

FIG. 6 is an illustration of an automotive jackstand.

FIG. 7 is an illustration of the interaction between an automotive jackstand and a cart utilizing casters having a spring.

FIG. 8 is a first diagrammatic illustration of a cart utilizing casters having a spring.

FIG. 9 is a second diagrammatic illustration of a cart utilizing casters having a spring.

FIG. 10 is an illustration of a jackstand utilizing casters having a spring.

FIG. 11 is a first diagrammatic illustration of a jackstand utilizing casters having a spring.

FIG. 12 is a second diagrammatic illustration of a jackstand utilizing casters having a spring.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

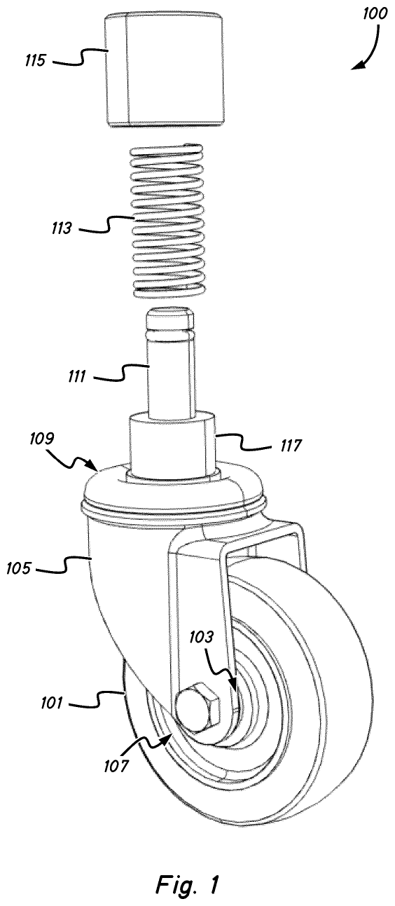

FIG. 1 shows an exploded view of a caster assembly. Caster 100 comprises a wheel 101 rotating about an axle 103. Axle 103 is disposed within a shell 105 having a distal end 107 and a proximal end 109. In the depicted embodiment, axle 103 is disposed near the distal end 107, but other embodiments may comprise other configurations without deviating from the teachings disclosed herein.

Shell 105 is configured to rotate about a stem 111. Stem 111 is configured to couple caster 100 to receptacles of larger assemblies for which it will be used. Caster 100 additionally comprises a spring 113, a collar 115 and a brace 117. In the depicted embodiment, the collar 115 is disposed at least partially around the stem 111 and spring 113, and is configured to receive a load from an external source, such as from an external assembly to which caster 100 is coupled. The load is transferred from the collar 115 to the spring 113, which is compressed against the brace 117. When the spring 113 is fully compressed, the collar 115 effectively transfers the load directly to the brace 117, as the spring 113 no longer provides mechanical force against the load.

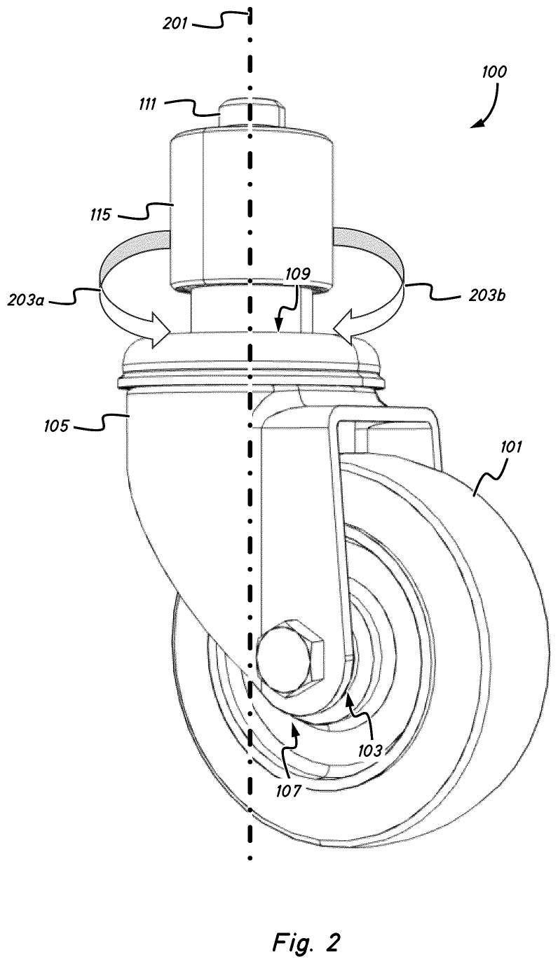

FIG. 2 is an assembled view of caster 100 with additional features illustrated. Stem 111 additionally defines an axis 201 about which shell 105 rotates in directions 203a and 203b. Directions 203a and 203b are inverse motions with respect to each other, and shell 105 is able to rotate about axis 201 in either direction in the depicted embodiment. Because axle 103 is disposed between members of the distal end 107 of shell 105, axle 103 will rotate in the same direction as shell 105. Accordingly, wheel 101 will additionally revolve around axis 201 because it is disposed upon axle 203. Some embodiments of caster 100 may comprise a different configuration without deviating from the teachings disclosed herein.

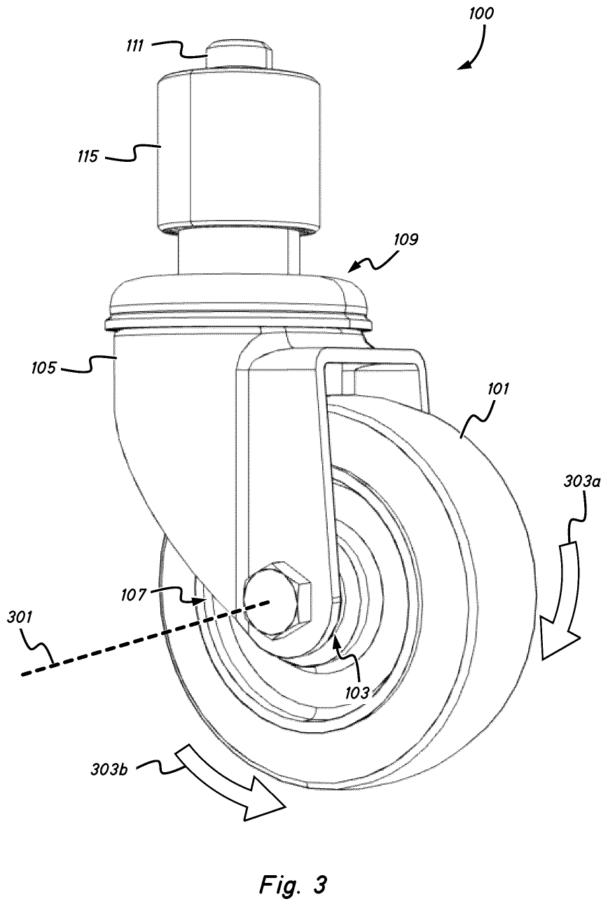

FIG. 3 is an additional assembled view of caster 100 with further features illustrated. Axle 103 defines an axis 301 about which wheel 101 rotates in directions 303a and 303b. Directions 303a and 303b are inverse motions with respect to each other, and wheel 101 is able to rotate about axis 301 in either direction in the depicted embodiment. The rotations of wheel 101 about axis 301 and shell 105 about axis 201 (not shown, see FIG. 2) result in caster 100 providing a wide degree of motion for an apparatus supported by caster 100.

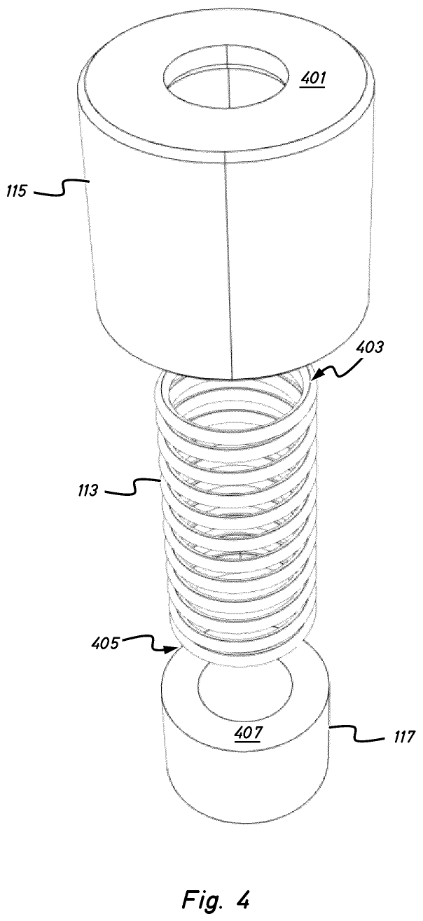

FIG. 4 is an exploded view of spring 113, collar 115, and brace 117 to illustrate additional details of the functions of spring 113 according to the depicted embodiment. In the depicted embodiment, collar 115 comprises a retaining wall 401. Retaining wall 401 engages with a proximal end 403 of spring 113 during assembly of the components. Retaining wall 401 is utilized to receive loads from external devices (such as an apparatus supported by the caster), but also to transfer the load to spring 113 via proximal end 403, resulting in a compression of the spring under load. The compression of spring 113 is achieved because a distal end 405 of spring 113 is abutted against a brace surface 407 of brace 117. As a load is applied to collar 115, spring 113 is compressed between the retaining wall 401 and brace surface 117. In response to receiving a load above a maximum load of spring 113, a maximum compression of spring 113 is achieved, and the distance between proximal end 403 and distal end 405 is minimized. In the maximum compression state, the load applied to spring 113 no longer receives any reciprocal force from the spring 113.

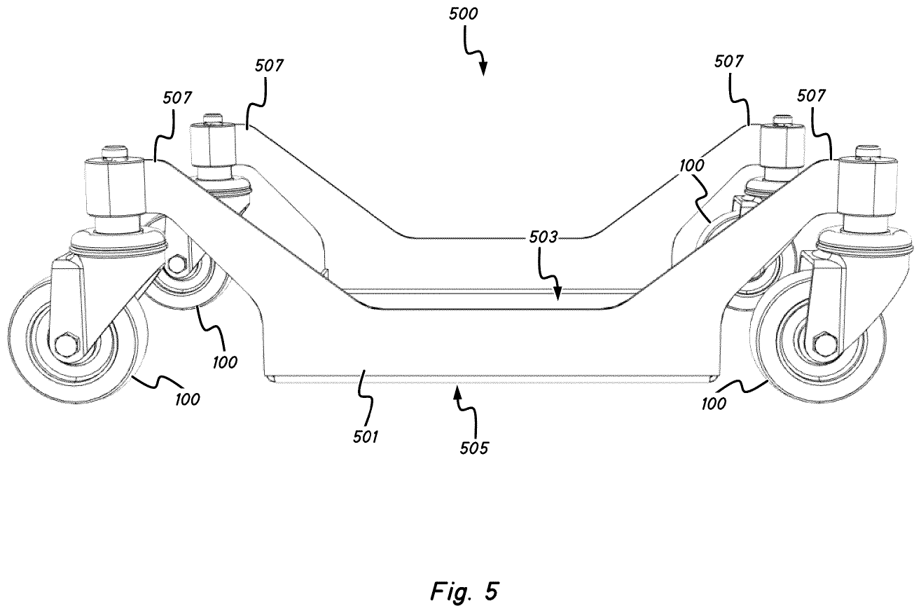

FIG. 5 depicts a cart 500 utilizing a plurality of casters 100. In the depicted embodiment, the cart comprises four casters 100, but other embodiments may comprise a different number without deviating from the teachings disclosed herein. In the depicted embodiment, all the casters of cart 500 are of the same configuration as caster 100, but other embodiments may comprise different configurations using 1 or more of casters 100 in combination with casters of other configurations without deviating from the teachings disclosed herein. In some such embodiments, some of the casters may comprise a wheel lock without deviating from the teachings disclosed herein.

Cart 500 comprises a shelf 501 suitable to receive a load. Shelf 501 has a top surface 503 configured to receive a load and a bottom surface 505. Bottom surface 505 is disposed at a clearance distance over the terrain supporting cart 500. The shelf 501 is coupled to each of casters 100 using a support arm 507. Each of support arms 507 is configured to couple to its respective caster 100 at a respective collar 115 (not shown, see FIG. 1-4). The coupling between each support arm 507 and its respective caster 100 is configured to transfer a load from shelf 501 to the casters 100. When no external load is applied to shelf 501, the springs 113 (not shown; see FIG. 1, FIG. 4) of each caster 100 are maximally extended, and the clearance distance from bottom surface 505 is maximized. When a load is applied to shelf 501, that load is transferred to springs 113, resulting in a degree in compression. When a load larger than a maximum load of the springs 113 is received, the springs exhibit maximum compression, and the clearance distance of bottom surface 505 over the terrain is minimized. In the depicted embodiment, the clearance distance of bottom surface 505 is rendered to zero when the springs 113 exhibit maximum compression when subjected to loads greater than the combined sum of their respective maximum thresholds, resulting in bottom surface 505 making contact with the terrain. The contact between bottom surface 505 and the terrain effectively transfers the additional load beyond what springs 113 can support directly to the terrain, preserving functionality of the springs 113.

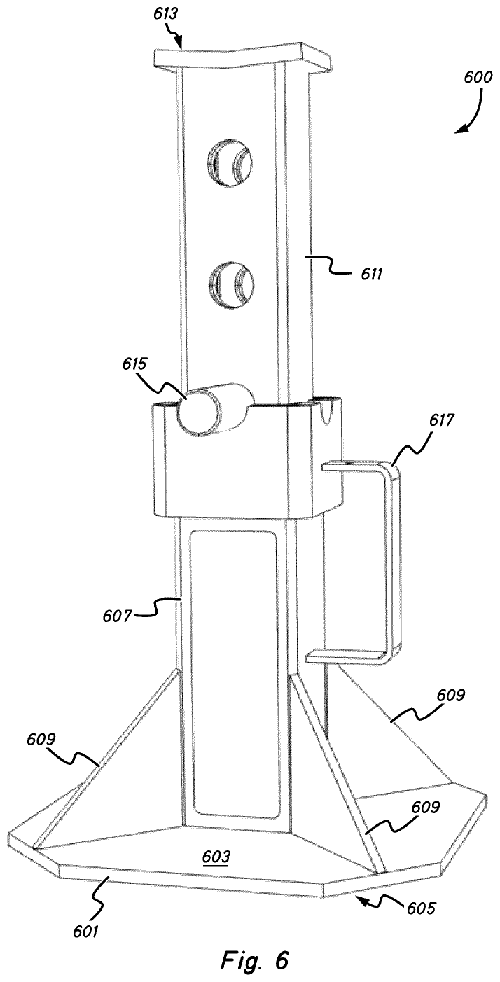

FIG. 6 is a depiction of a jackstand 600 configured for use with cart 500 (see FIG. 5). Jackstand 600 comprises a base member 600 having a top surface 603. Projecting from the top surface 603 is a sleeve 607 supported by a number of sleeve supports 609. Extending from sleeve 607 is a support arm 611 having a support surface 613 that is configured to receive a load, such as from the frame of an automobile (not pictured). The extension of support arm 611 is fixed using a locking mechanism 615. In the depicted embodiment, the locking mechanism 615 comprises a peg lock, but other embodiments may comprise other configurations without deviating from the teachings disclosed herein. By way of example, and not limitation, such embodiments may comprise a ratchet lock, a vice lock, a latch lock, a channel lock, or any other locking mechanism known to one of ordinary skill in the art without deviating from the teachings disclosed herein. In the depicted embodiment, jackstand 600 further comprises a handle 617 which may be utilized by a user to move, position, or carry the jackstand 600. Some embodiments may not comprise a handle 617 without deviating from the teachings disclosed herein.

Jackstand 600 exhibits a set of characteristics that make it suitable for use with automotive vehicle loads. By way of example, and not limitation, jackstand 600 may be specified to support up to 20 tons of force as received by support surface 613, but other embodiments may comprise a different maximum load without deviating from the teachings disclosed herein.

The self-mass of jackstand 600 influences its total maximum capacity, with larger and heavier configurations being capable of supporting higher loads. In some embodiments, jackstand 600 may itself weight between 25-50 pounds when not subject to any external load. In the depicted embodiment, jackstand 600 weighs 45 pounds, but other embodiments may comprise other weights without deviating from the teachings disclosed herein.

The dimensions of base member 603 will additionally influence the performance of jackstand 600, with larger dimensions providing a wider and more stable support for received loads. In the depicted embodiment, base member 603 comprises a cropped rectangle shape, having 4 large sides (similar to a rectangle) and 4 short sides, creating an irregular octagon, but other embodiments may comprise different shapes and sizes without deviating from the teachings disclosed herein. By way of example, and not limitation, the total length of each dimension of base member 603 may be between 10-16 inches long without deviating from the teachings disclosed herein. In the depicted embodiment, the total area of base member 603 will fit within a 15.5-inch by 15.5-inch square, but other embodiments may comprise other configurations. In some such embodiments, base member 603 may fit within an 11-inch by 11-inch square without deviating from the teachings disclosed herein.

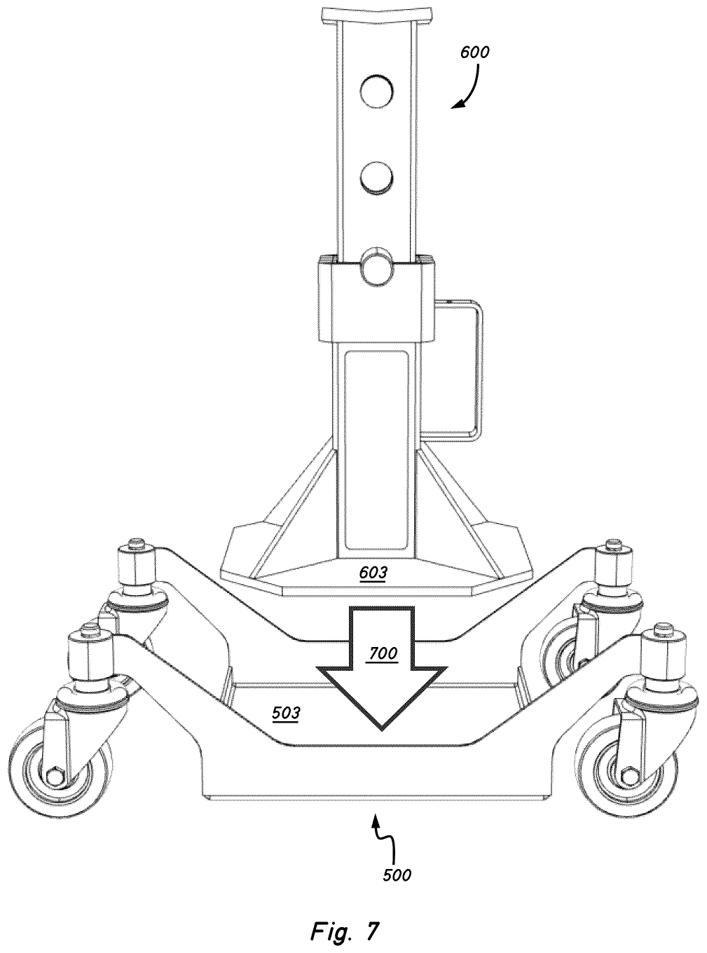

FIG. 7 is an exploded view of jackstand 600 engaging with cart 500. The weight of jackstand 600 applies a force 700 to cart 500 when the cart 500 receives the load of jackstand 600. In the depicted embodiment, top surface 503 comprises dimensions that will readily accept base member 603 to provide an optimally secure coupling when receiving the load of jackstand 600. In the depicted embodiment, top surface 503 may comprise a 15.5-inch by 15.5-inch rectangle in order to most securely receive jackstand 600, but other embodiments may comprise other dimensions without deviating from the teachings disclosed herein. Top surface 503 need not be the exact dimensions of base member 603, and instead may only be large enough to accommodate the dimensions of the base member 603. In this manner, cart 500 is advantageously suitable to support a variety of jackstands having different dimensions without deviating from the teachings disclosed herein.

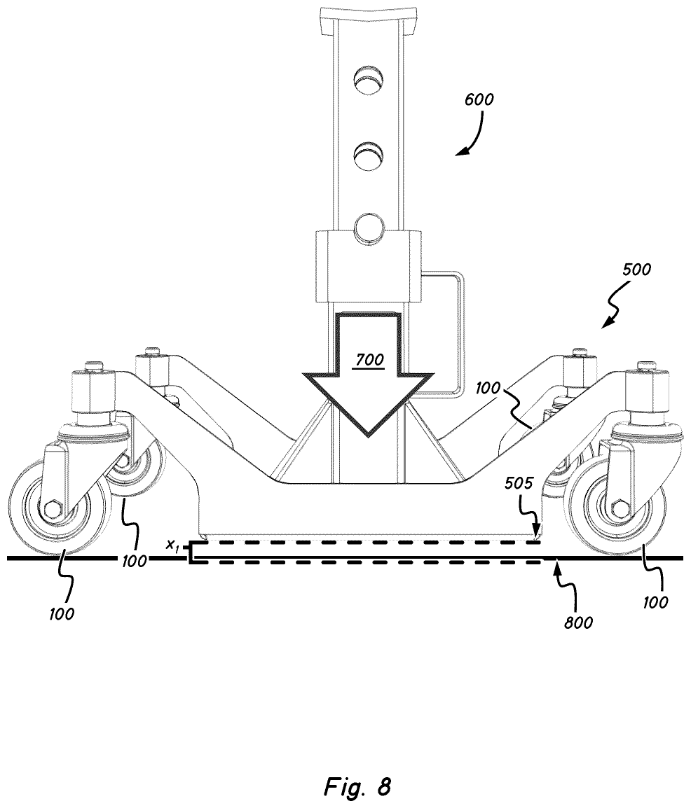

FIG. 8 is an illustration of jackstand 600 engaged with cart 500 on a supporting terrain surface 800. In the depicted embodiment, the weight force 700 of jackstand 600 is supported by springs 113 (not shown; see FIG. 1) of the casters 100 of cart 500. The combined force of springs 113 is sufficient to receive force 700 while still disposed such that bottom surface 505 is at a nominal clearance distance x₁ over terrain surface 800. This clearance distance x₁ is suitable to permit cart 500 to freely be moved about terrain surface 800 using casters 100 in normal operating conditions.

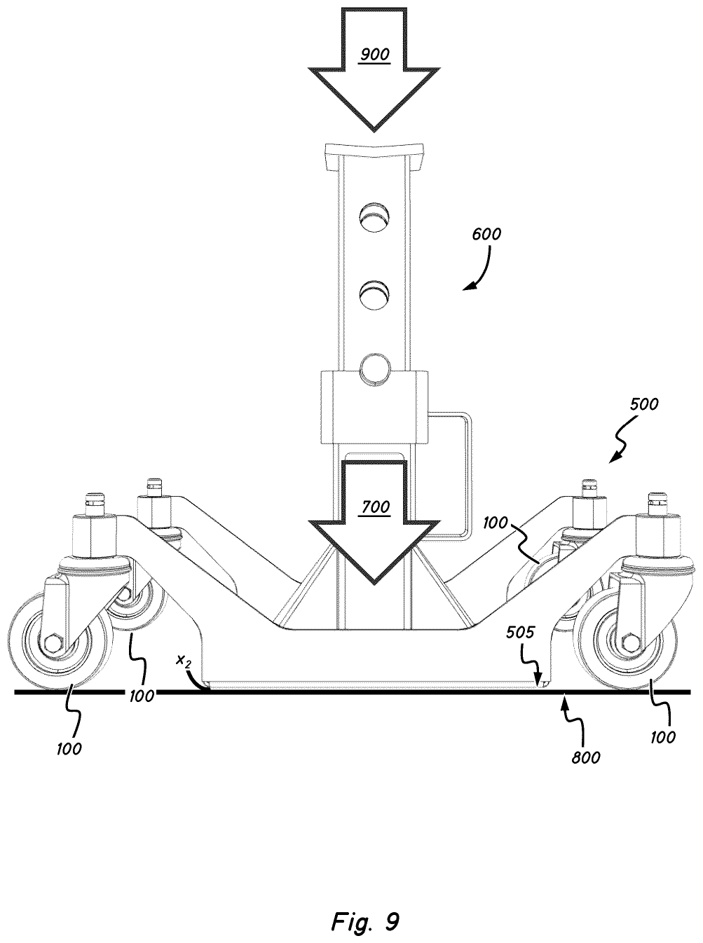

FIG. 9 is an illustration of jackstand 600 engaged with cart 500 on supporting terrain surface 800. However, in addition to the weight force 700 of jackstand 600, cart 500 is additionally subjected to an external load force 900. The combined loads of weight force 700 and external load force 900 is greater than the total combined maximum load of springs 113 (not shown; see FIG. 1) in casters 100. This combined load is forces each of springs 113 into a state of maximal compression, and the new clearance distance x₂ is reduced to zero. At this distance, bottom surface 505 comes into contact with terrain surface 800, which results in maximal friction between cart 500 and terrain surface 800, as well as a direct transfer of additional load beyond the maximum threshold of springs 113 directly into the terrain surface 800. In this manner, jackstand 600 is able to provide support for loads greater than the maximum specified loads of casters 100 safely and securely, without damaging cart 500. In the event that external load force 900 is reduced such that the springs are no longer maximally compressed, the clearance distance between bottom surface 505 and terrain surface 800 will return to a value greater than zero, and cart 500 will again become mobile utilizing the rolling mechanisms of casters 100.

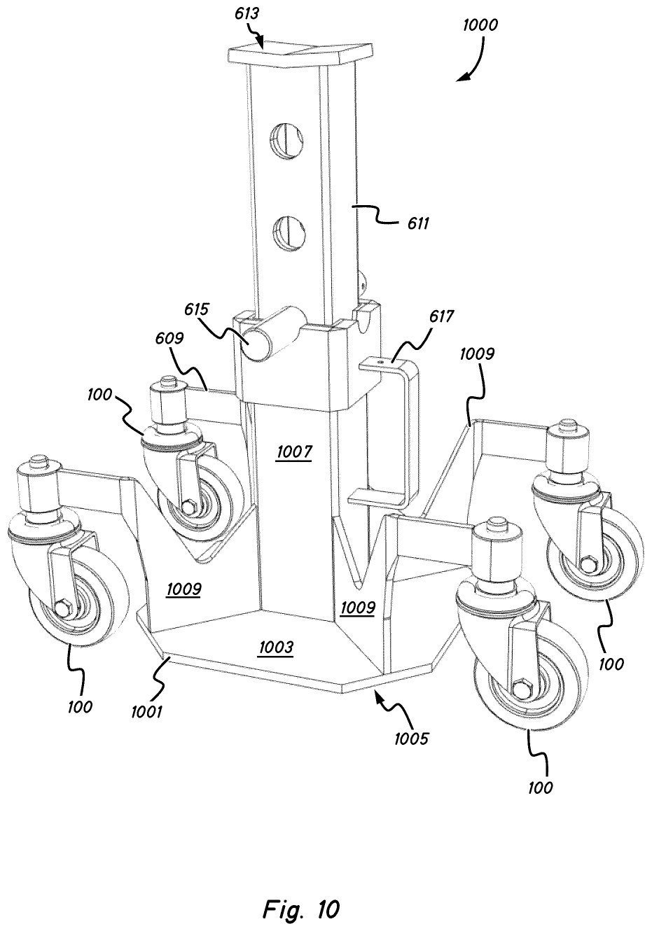

In some embodiments, a distinct jackstand and cart configuration may not be desirable compared to an integrated solution. FIG. 10 presents a jackstand 1000 that comprises features of jackstand 600 (see FIG. 6) and cart 500 (see FIG. 5). In the particular depicted embodiment, jackstand 1000 comprises identical casters 100 to cart 500 (see also FIG. 1), and identical support arm 611 having a support surface 613, locking mechanism 615, and handle 617 as jackstand 600. Jackstand 1000 additionally comprises a base member 1001 having a top surface 1003 and bottom surface 1005 very similar to the base member 501, top surface 1003, and bottom surface 1005 of cart 500 in form, and each of these components functions similarly. Jackstand 1000 additionally features a sleeve 1007 projecting from top surface 1003 that functions very similarly to the sleeve 607 of jackstand 600. Lastly, jackstand 1000 additionally features a number of supports 1009 which provide the functionality to support sleeve 1007 in a manner very similar to sleeve supports 609, while additionally coupling casters 100 to base member 1001 in a manner very similar to the functions of support arms 507 of cart 500. In combining these elements, jackstand 1000 advantageously transfers loads from support arm 611 to base member 1001 and supports 1009 more efficiently, because each of these elements is coupled and affixed together in an integrated fashion to maximize load transfers.

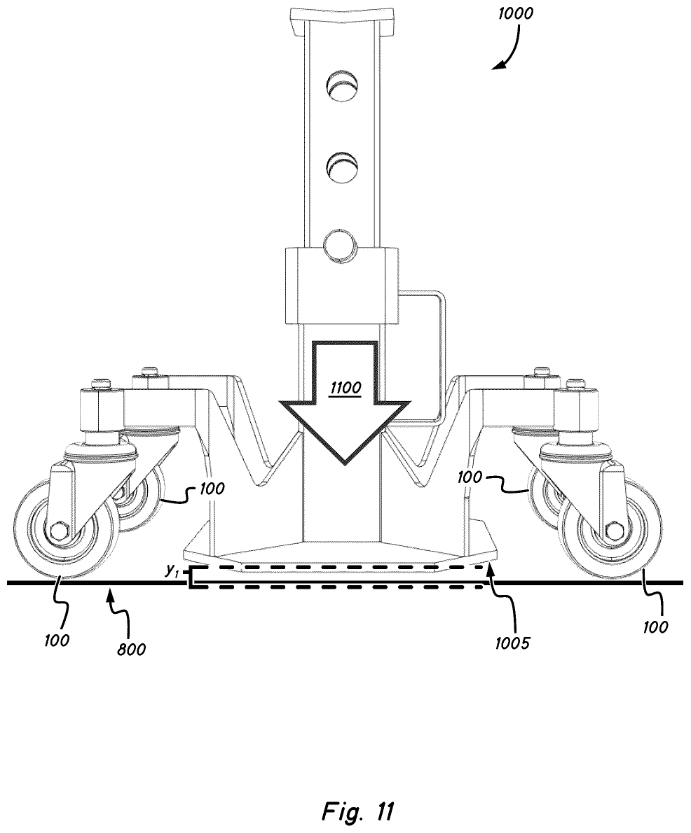

FIG. 11 is an illustration of jackstand 1000 on a supporting terrain surface 800. In the depicted embodiment, the weight force 1100 of jackstand 1000 is supported by springs 113 (not shown; see FIG. 1) of the casters 100. The combined force of springs 113 is sufficient to receive force 1100 while still disposed such that bottom surface 1005 is at a nominal clearance distance y₁ over terrain surface 800. This clearance distance y₁ is suitable to permit jackstand 1000 to freely be moved about terrain surface 800 using casters 100 in normal operating conditions.

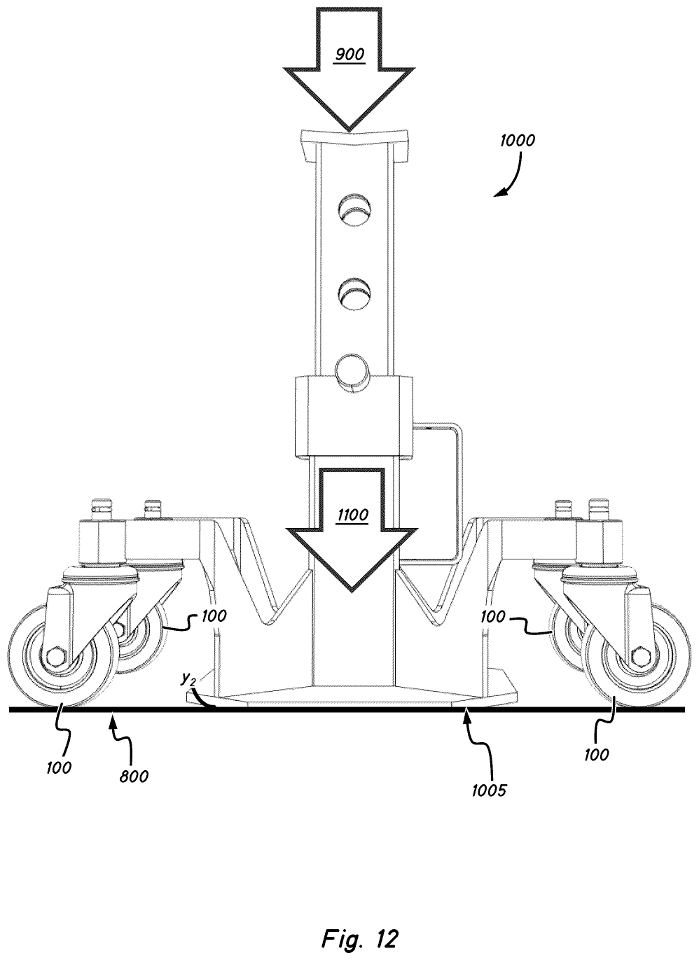

FIG. 12 is an illustration of jackstand 1000 on supporting terrain surface 800. However, in addition to the weight force 1100 of jackstand 1000, jackstand 1000 is additionally subjected to an external load force 900. The combined loads of weight force 1100 and external load force 900 is greater than the total combined maximum load of springs 113 (not shown; see FIG. 1) in casters 100. This combined load is forces each of springs 113 into a state of maximal compression, and the new clearance distance y₂ is reduced to zero. At this distance, bottom surface 1005 comes into contact with terrain surface 800, which results in maximal friction between jackstand 1000 and terrain surface 800, as well as a direct transfer of additional load beyond the maximum threshold of springs 113 directly into the terrain surface 800. In this manner, jackstand 1000 is able to provide support for loads greater than the maximum specified loads of casters 100 safely and securely, without damage. In the event that external load force 900 is reduced such that the springs are no longer maximally compressed, the clearance distance between bottom surface 505 and terrain surface 800 will return to a value greater than zero, and cart 500 will again become mobile utilizing the rolling mechanisms of casters 100.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A caster assembly comprising:
a stem defining a first axis;
a shell comprising a proximal end and a distal end, the shell coupled to the stem at the proximal end and coupled such that the shell is rotatable about the first axis;
an axle coupled to the shell at the distal end, the axle defining a second axis orthogonal to the first axis;
a wheel disposed about the axle, the wheel being rotatable about the second axis;
a spring extending along at least a portion of the stem; and
a collar at least partially disposed around the stem and spring, the collar configured to receive a load and transfer the load onto the spring.

2. The caster assembly of claim 1, wherein the spring is fully compressed when subjected to a load above a maximum load.

3. The caster assembly of claim 2, wherein the maximum load is 6-13 pounds.

4. A cart comprising:
a shelf having a top surface and a bottom surface, the top surface configured to receive a load and the bottom surface being disposed at a clearance distance over a terrain surface supporting the cart; and
a caster coupled to the shelf, the caster having a configuration that includes
a stem defining a first axis,
a shell comprising a proximal end and a distal end, the shell coupled to the stem at the proximal end and coupled such that the shell is rotatable about the first axis,
an axle coupled to the shell at the distal end, the axle defining a second axis orthogonal to the first axis,
a wheel disposed about the axle, the wheel being rotatable about the second axis,
a spring extending along at least a portion of the stem, and
a collar at least partially disposed around the stem and spring, the collar configured to receive a load and transfer the load onto the spring,
wherein the shelf is configured to transfer a received load to the collar such that the clearance distance is maximized when the shelf is not subject to a load, wherein the spring is maximally displaced when subjected to a load greater than a maximum load for the spring, and wherein the maximized clearance distance is not greater than the maximum displacement.

5. The cart of claim 4, wherein the caster is one of a plurality of casters.

6. The cart of claim 5, wherein each of the plurality of casters has the same configuration.

7. The cart of claim 5, wherein the plurality of casters comprises four casters.

8. The cart of claim 7, wherein each of the four casters has the same configuration.

9. The cart of claim 8, wherein the maximum load of each of the four casters is 10 pounds.

10. The cart of claim 8, wherein the maximum load of each of the four casters is 13 pounds.

11. The cart of claim 4, wherein the maximum load is 6-13 pounds.

12. The cart of claim 4, wherein a length of a first dimension of the shelf is 10-16 inches.

13. The cart of claim 12, wherein a length of a second dimension of the shelf is 10-16 inches.

14. The cart of claim 13, wherein the shelf comprises a square, wherein each side of the square is 10-16 inches.

15. The cart of claim 14, wherein the shelf is a 11 inch by 11 inch square.

16. The cart of claim 14, wherein the shelf is a 16 inch by 16 inch square.

17. A jackstand comprising:
a base member having a top surface and a bottom surface, the bottom surface disposed at a clearance distance over a terrain surface supporting the jackstand;
a support arm configured to extend from the top surface and receive a load;
a caster coupled to the base member, the caster having a configuration including
a stem defining a first axis,
a shell comprising a proximal end and a distal end, the shell coupled to the stem at the proximal end and coupled such that the shell is rotatable about the first axis,
an axle coupled to the shell at the distal end, the axle defining a second axis orthogonal to the first axis,
a wheel disposed about the axle, the wheel being rotatable about the second axis,
a spring extending along at least a portion of the stem, and
a collar at least partially disposed around the stem and spring, the collar configured to receive a load and transfer the load onto the spring,
wherein the base member is configured to transfer a received load of the support arm to the collar such that the clearance distance is maximized when the support arm is not subject to a load, wherein the spring is maximally displaced when subjected to a load greater than a maximum load for the spring, and wherein the maximized clearance distance is not greater than the maximum displacement.

18. The jackstand of claim 17, wherein the caster is one of four casters, and the maximum load for each of the four casters is between 6-13 pounds.

19. The jackstand of claim 18, wherein the maximum load for each of the four casters is 10 pounds.

20. The jackstand of claim 17, wherein the support arm is configured to support a maximum load of 20 tons.
